(19) United States
(12) Patent Application Publication
(10) Pub. No.: US 2006/0042517 A1
(43) Pub. Date: Mar. 2, 2006

(54) Methods of reducing hydroxyl ions in concrete pore solutions

(76) Inventors: Paul W. Brown, State College, PA (US); Wendy E. Brown, State College, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/927,733

(22) Filed: Aug. 27, 2004

(51) Int. Cl. C04B 28/04

(52) U.S. Cl. 106/713

(57) ABSTRACT

Methods of reducing hydroxyl ions in concrete pore solutions are provided. Such methods are useful in providing resistance to gels which form in concrete due to the alkali-silica (ASR) reaction. The methods comprise, in one aspect, adding a salt to the concrete, in aqueous or solid form, the salt having a cation higher in valence than the anion. In other aspects, the methods of the present invention comprise adding an acidic phosphate or a silicon-containing alkoxide to the concrete. All of the above methods are useful in reducing hydroxyl ions in concrete. Such methods can be used to prevent ASR in fresh concrete, or to remediate ASR in hardened concrete.

### FIELD OF THE INVENTION

The present invention relates to methods of reducing hydroxyl ions in concrete pore solutions by the addition of inorganic or organic acids or salts such as Ca(NO₂)₂, Ca(NO₃)₂ or calcium acetate.

### BACKGROUND INFORMATION

Concrete is a conglomerate of aggregate (such as gravel, sand, and/or crushed stone), water, and hydraulic cement (such as portland cement), as well as other components and/or additives. Concrete is initially fluid-like when it is first made, enabling it to be poured or placed into shapes. After hardening this property is lost. When concrete is mixed, it takes about twenty-eight percent of the weight of cement as water to fully consume all the cement in making hydration products. However, it is not possible to attain a fluid mix with such a small amount of water, and more water than is needed is added. The additional water simply resides in the pores present in concrete, and is referred to as the pore liquid or pore solution.

When Portland cement is mixed with water to produce concrete, the alkali oxides present in the cement, Na₂O and K₂O, dissolve. Alkali materials are supplied by the cement, aggregate, additives, and even from the environment in which the hardened concrete exists (such as salts placed on concrete to melt ice). Thus, the pore solution produced becomes highly basic. It is not unusual for this pore solution to attain a pH or 13.3 or higher. Depending on the aggregate used in the concrete, a highly basic pore solution may interact chemically with the aggregate. In particular, some sources of silica in aggregate react with the pore solution. This process is called the alkali-silica reaction (ASR) and may result in formation of a gelatinous substance which may swell and cause damage to the concrete. The swelling can exert pressures greater than the tensile strength of the concrete and cause the concrete to swell and crack. The ASR reaction takes place over a period of months or years.

Although the reaction is referred to as the alkali-silica reaction, it will be appreciated that it is the hydroxyl ions that are essential for this reaction to occur. For example. ASR will not occur if silica-containing aggregates are placed in contact with alkali nitrate solutions with Na or K concentrations comparable to those which result in ASR if those solutions were alkali hydroxides.

In extreme cases, ASR can cause the failure of concrete structures. More commonly, ASR weakens the ability of concrete to withstand other forms of attack. For example, concrete that is cracked due to this process can pen-nit a greater degree of saturation and is therefore much more susceptible to damage as a result of “freeze-thaw” cycles. Similarly, cracks in the surfaces of steel reinforced concrete can compromise the ability of the concrete to keep out salts when subjected to deicers, thus allowing corrosion of the steel it was designed to protect.

There are a number of strategies which have been used to mitigate or eliminate ASR. One strategy is to reduce the alkali content of the cement. Cements containing less than 0.6 wt % Na₂O equivalent are called low alkali. However, merely using a low alkali cement does not ensure that the alkali silica reaction can be avoided. Another common strategy is the intentional addition of a source of reactive silica, which acts as an acid to neutralize the alkali. Such sources are fine powders and are typically silica fume (a high surface area SiO₂ formed as a by-product of making ferro-silicon), fly ash (high surface area materials produced in the combustion of coal which contains SiO₂), and natural pozzolans (high surface area materials produced which contains SiO₂ and which are typically produced by volcanic action).

Another technology involves the addition of a soluble source of lithium such as LiOH or LiNO₃. The mechanism of action of Li is not entirely resolved, but it appears to stabilize the alkali silica gels which form. These Li-containing gels then appear to provide a low permeability layer over the underlying reactive material.

There are economic and other disadvantages with most of the above methods. For example, lithium compounds are very expensive and have therefore not gained much acceptance. The use of mineral admixtures such as silica fume or fly ash requires additional storage silos, and requires additional mixing. Further, silica fume is expensive, and if not properly blended into the concrete can actually cause ASR. Finally, combustion technology is changing to reduce NOₓ emissions, which in turn makes fly ash less reactive and thus less suitable as an additive to reduce ASR. Fly ash and silica fume are not suitable for treatment of existing structures. There remains a need for economic and effective methods of reducing ASP, in concrete.

### SUMMARY OF THE INVENTION

The present invention solves the above needs, by providing methods of reducing hydroxyl ions in concrete. In one aspect, the present invention provides a method of reducing hydroxyl ions in concrete pore solutions containing alkali metal cations and hydroxyl ions, comprising adding a salt to the concrete. The salt comprises a cation, denoted herein as Cat, and an anion, denoted herein as An, the cation having a higher valence than the anion. Additionally, the Cat-An salt should have a solubility in water that is greater than Cat-OH, such that when the Cat-An salt dissociates and the Cat precipitates as Cat-OH, the resulting alkali metal-An salt formed remains in solution or has a solubility in the concrete pore solution greater than that of said Cat-An salt.

In another aspect, the present invention provides a method of reducing hydroxyl ions in concrete pore solutions containing alkali metal cations and hydroxyl ions, comprising adding a salt to said concrete, wherein said salt comprises a cation and an anion, said cation having a higher valence than said anion. In this embodiment, the Cat-An salt will have a solubility in concrete pore solutions having pH values higher than that of a saturated Cat(OH)₂ solution in water that is greater than Cat-OH, such that when said Cat-An salt precipitates as Cat-OH the resulting alkali metal-An salt formed remains in solution or has a solubility in water greater than that of said Cat-An salt. This embodiment embraces those anions such as oxalate which are less soluble than Cat-OH in water, but which become more soluble than Cat-OH when the pH of the solution reaches about 13.

In an additional aspect, the present invention provides a method of reducing hydroxyl ions in concrete pore solutions, comprising adding an acidic phosphate to the concrete.

In all of the above methods, hydroxyl ions are substantially reduced in the pore solution. While the alkali-silica reaction has been recognized for decades, it was generally not thought to be a problem of excess hydroxyl ions in the pore solution, and remediation efforts did not focus on this aspect. Additionally the addition of acids to concrete was thought to have a detrimental effect on the desired properties of the concrete. See, e.g., Lea, The Chemistry of Cemeni and Concrete, pp. 659-676 (Ch 20), which describes the actions of various compounds on concrete, including ammonium acetate, aluminate nitrate, lactic acid, acetic acid, tartaric acid, citric acid and malic acid. All of these are stated to cause attack on the concrete. Oxalic acid exhibits only a minor effect due to the low solubility of Ca oxalate.

It is an object of the present invention, therefore, to provide methods of reducing hydroxyl ions in concrete.

It is an additional object of the present invention to provide a method of reducing hydroxyl ions in concrete by the addition of a salt, an acidic phosphate, or a silicon-containing alkoxide.

These and other aspects of the present invention will become more readily apparent from the following detailed description and appended claims.

### DETAILED DESCRIPTION OF PREFERRED EMBODIMENTS

In one aspect, the present invention provides a method of reducing hydroxyl ions in concrete pore solutions containing alkali metal cations and hydroxyl ions, comprising adding a salt to said concrete. The salt comprises a cation, denoted herein as Cat, and an anion, denoted herein as An, the cation having a higher valence than the anion. Additionally, the Cat-An salt should have a solubility in water that is greater than Cat-OH, such that when the Cat-An salt dissociates, the Cat-OH precipitates, and the resulting alkali metal-An salt formed remains in solution or has a solubility in the concrete pore solution greater than that of said Cat-An salt.

In another embodiment, the present invention provides a method of reducing hydroxyl ions in concrete pore solutions containing alkali metal cations and hydroxyl ions, comprising adding a salt to said concrete, wherein said salt comprises a cation, denoted herein as Cat, and an anion, denoted herein as An, said cation having a higher valence than said anion. In this embodiment, the Cat-An salt will have a solubility in concrete pore solutions having pH values higher than that of a saturated Cat(OH)₂ solution in water that is greater than Cat-OH, such that when said Cat-An salt precipitates as Cat-OH the resulting alkali metal-An salt formed remains in solution or has a solubility in water greater than that of said Cat-An salt. This embodiment embraces those anions, such as oxalate described below, which are less soluble than Cat-OH in water, but which become more soluble than Cat-OH when the pH of the solution reaches about 13.

Any salt containing a suitable cation can be used, so long as the cation has a valence higher than that of the anion and the salt meets the above listed criteria. Suitable cations include, but are not limited to, Ca, Fe, Mg, Mn. Al, Cu, Zn, Sr, Ti and combinations of these. Preferred cations are Ca, Mg, Fe and Al. The most preferred cation is Ca.

Similarly, any salt with a suitable anion can be used, provided that the valence and solubility criteria described above are met. Additionally, the anion must be innocuous in concrete, and should not affect the desirable qualities of concrete such as hardening and durability, and should not subject the reinforcing steel elements in concrete to attack. Thus, certain anions such as chlorides, sulfates and carbonates would not be suitable for use in concrete. Suitable anions can be either organic and inorganic anions, including, but not limited to, nitrate, nitrite, acetate, benzoate, butyrate, citrate, formate, fumarate, gluconate, glycerophosphate, isobutyrate, lactate, maleate, methylbutyrate, oxalate, propionate, quinate, salicylate, valerate, chromate, tungstate, ferrocyanide, permanganate, monocalcium phosphate monohydrate (Ca(HPO₄)₂.H₂O), hypophosphate, and combinations thereof. Preferred anions include nitrate, nitrite, acetate and oxalate. This list is not meant to be exhaustive, and organic anions that are polymers, such as ionomers and polyelectrolytes, and/or oligomers can be used, provided that they meet the criteria described above. Examples of suitable salts are found in Tables 1, 2 and 3.

As will be appreciated by one skilled in the art, the salt can be added to fresh concrete, in solid or aqueous form, or can be introduced into hardened concrete as an aqueous solution. The salt can also be used to remediate existing concrete by means of an overlay, and can be added to the fresh overlay or the hardened overlay as desired. As used herein, the term “added”, as in “added to concrete”, means the addition of the hydroxyl-removing material to fresh concrete in solid or aqueous form, as well as the introduction of the material into hardened concrete, typically in aqueous form. Methods of mixing the components used to make concrete are standard and well known in the art.

As described more fully below in the examples, the amount of salt added will be that amount sufficient to bring the effective Na₂O equivalent to an amount which is less than the effective Na₂O equivalent in the cement used in the concrete, more preferably to an amount which is sufficient to bring the effective Na₂O equivalent to less than about 0.8% by weight of the cement in the concrete, most preferably to less than about 0.6% by weight of cement in said concrete.

Using calcium nitrate as an example, the following reaction will occur:
Ca(NO₃)₂.xH₂O_{(s or aq)}+2AOH_{(aq)}→Ca(OH)₂₍ₛ₎+2ANO_{3(aq)}.
This reaction consumes hydroxyls and, provided that the salt is added in sufficient quantity, it limits the OH concentration to that provided by the calcium hydroxide. Note that even if the salt is added in great excess, the OH concentration will remain nominally the same, namely that of calcium hydroxide.

There is a specific advantage to an organic salt that has molar solubility close to that of calcium hydroxide. Additions of salts to the mixing water may cause acceleration of the rate of setting. This is undesirable when concrete is placed in warm weather. If the common ion effect of calcium on some of the organic salts is considered, their dissolution will be retarded by elevated calcium ion concentrations in solution. Thus, during the early hydration, the calcium entering solution as a result of cement hydration will inhibit the dissolution organic Ca salts. However, as the Ca drops in response to Na and K entering solution, through the common ion effect of hydroxyl on the solubility of calcium hydroxide, then the organic salts will dissolve, and in doing so reduce the hydroxyl ion concentration. Using nitrate salts as examples of the reactions of interest are as follows:

(wherein A=Na and/or K)
Al(NO₃)₃.xH₂O_{(s or aq)}+3AOH_{(aq)}→Al(OH)₃₍ₛ₎+3ANO_{3(aq)}
Fe(NO₃)₃.xH₂O_{(s or aq)}+3AOH_{(aq)}→Fe(OH)₃₍ₛ₎+3ANO_{3(aq)}

Alternatively:
Fe(NO₃)₃.xH₂O_{(s or sq)}+3AOH_{(sq)}→FeOOH₂₍ₛ₎+3ANO_{3(aq)}
Fe(NO₃)₂.xH₂O_{(s or aq)}+2AOH_{(aq)}→Fe(OH)₂₍ₛ₎+2ANO_{3(aq)}
Ca(NO₂)₂.xH₂O_{(s or sq)}+2AOH_{(aq)}→Ca(OH)₂₍ₛ₎+2ANO_{2(aq)}
Ca(NO₃)₂.xH₂O_{(s or aq)}+2AOH_{(aq)}→Ca(OH)₂₍ₛ₎+2ANO_{3(aq)}
Mg(NO₂)₂.xH₂O_{(s or aq)}+2AOH_{(aq)}→Mg(OH)₂₍ₛ₎+2ANO_{2(aq)}
Mg(NO₃)₂.xH₂O_{(s or sq)}+2AOH_{(sq)}→Mg(OH)₂₍ₛ₎+2ANO_{3(aq)}
Zn(NO₂)₂.xH₂O_{(s or sq)}+2AOH_{(aq)}→Zn(OH)₂₍ₛ₎+2ANO_{2(aq)}
Zn(NO₃)₂.xH₂O_{(s or aq)}+2AOH_{(aq)}→Zn(OH)₂₍ₛ₎+2ANO_{3(aq)}
Sr(NO₂)₂.xH₂O_{(s or aq)}+2AOH_{(aq)}→Sr(OH)₂₍ₛ₎+2ANO_{2(aq)}
Sr(NO₃)₂.xH₂O_{(s or sq)}+2AOH_{(aq)}→Sr(OH)₂₍ₛ₎+2ANO_{3(aq)}
Sn(NO₂)₂.xH₂O_{(s or q)}+2AOH_{(aq)}→Sn(OH)₂₍ₛ₎+2ANO_{2(aq)}
Sn(NO₃)₂.xH₂O_{(s or aq)}+2AOH_{(aq)}→Sn(OH)₂₍ₛ₎+2ANO_{3(aq)}

The free water produced in these reactions is ignored. x may be 0 for anhydrous nitrates and nitrites or may be various numbers specific to a particular compound. Some nitrates and nitrite compounds may have a number of different hydrates, and in these cases there will be a range of possible values for x.

More generalized versions of the above equations are as follows:
Cat(An)₂.xH₂O_{(s or aq)}+2AOH_{(aq)}→Cat(OH)₂₍ₛ₎+2AAn_{(aq)}
Cat(An)₃.xH₂O_{(s or aq)}+3AOH_{(aq)}→Cat(OH)₃₍ₛ₎+3AAn_{(aq)}
where Cat refers to cation, An refers to anion, and A refers to alkali metal.

The possibility of the formation of a soluble intermediate ASn(OH)₃ is recognized. The above list is exemplary and not meant to be exhaustive, and 4 and 5 valent nitrates and nitrites can also be used:
Eg. Ti(NO₃)₄.xH₂O_{(s or aq)}+4AOH_{(aq)}→TiO₂₍ₛ₎+4ANO_{3(aq)}

In another aspect, the present invention provides a method of reducing hydroxyl ions in concrete pore solutions, comprising adding an acidic phosphate to the concrete. Any suitable acidic phosphate can be used, so long as it has the ability to release a proton in exchange for picking up a Na⁺ or K⁺. Preferably, the acidic phosphate is phosphoric acid, monobasic phosphate, or dibasic phosphate, or combinations of these. The cation of the acidic phosphate can be selected from the group consisting of Na⁺, K⁺, NH₄⁺ and combinations thereof. The acidic phosphate can be added to fresh concrete as a solid or as an aqueous solution, and can also be introduced into hardened concrete. It can also be used in an overlay over existing concrete, as described above. The amount used is as described above for addition of a salt.

The following reaction, by way of example only, illustrates this aspect of the present invention:
E.g. NaH₂PO_{4(s or aq)}+Na⁺+OH⁻→Na₂HPO_{4(s or aq)}+HOH
In this, a buffering reaction, monobasic sodium phosphate is converted to dibasic sodium phosphate. In this conversion a proton is liberated and its reaction with an hydroxyl produces water. This class of reactions differs from those described above because a solid hydroxide is not precipitated.

In The Chemistry of Silica by Iler, (figure 1.6, p. 42) the solubility of amorphous silica as a function of pH is shown. Solubility increases by a factor of about 10 or more between pH 9 and pH 11, and continues to increase with further pH elevation. Certain types of aggregate used in concrete contain silicate minerals which show elevated silica solubility at the pH values normally present in concrete pore solutions. The elevated pH values of these solutions are the result of the presence of alkali hydroxides.

It is has been recognized that alkali silicates in liquid form may be added to concrete as a means of pore blocking. For example, potassium silicate solutions may be added to hardened concrete to react with available calcium hydroxide to produce calcium silicate hydrate. However, this would not be an acceptable means for mitigating the effects of ASR because the reactions involved also produce a potassium hydroxide solution.

As described above, basicities of concrete pore solutions can be reduced by the addition of salts comprised of a polyvalent cation and an anion of a strong acid. Another method to achieve a reduction in hydroxyl ion concentration is the direct addition of an appropriate acid species. The direct addition of an acid at the time of mixing of fresh concrete is theoretically possible, provided an appropriate acid could be found. Addition of an acid to hardened concrete is also theoretically possible, provided that such an acid could be found and could be made to intrude the concrete pore structure.

One such acid is silicic acid. It is also accepted that hydrous silica is an acid: SiO₂.2H₂O═H₄SiO₄. Acidic silicates in solid form, including those present in fly ash, in silica fume, and in natural pozzolans, are routinely added to fresh concrete. Thus, a method by which hydrous silica could be added to in-place concrete also has the capability of reducing the alkali-silica reaction. Such a method involves the addition of a silicon-containing alkoxide. Commonly available alkoxides include tetramethyloxysilane (TMOS) (CH₃O)₄Si, tetraethyloxysilane (TEOS) (C₂H₅O)₄Si, and ethyl silicate 40. The latter is a solution of partially hydrolyzed TEOS comprised of oligomers containing on average 5 silicon atoms per oligomer. These alkoxides produce hydrous silica by a combination of hydrolysis and condensation reactions.

Using TEOS as an example, the following hydrolysis reactions occur to produce an amorphous silicate:
(C₂H₅O)₄Si+H₂O→(C₂H₅O)₃SiOH+C₂H₅OH.
(C₂H₅O)₃SiOH+H₂O→(C₂H₅O)₂Si(OH)₂+C₂H₅OH
(C₂H₅O)₂Si(OH)₂+H₂O→C₂H₅OSi(OH)₃+C₂H₅OH
C₂H₅OSi(OH)₃+H₂O→Si(OH)₄+C₂H₅OH
More broadly, these equations can be written as:
(RO)₄Si+H₂O→(RO)₃SiOH+ROH.
(RO)₃SiOH+H₂O→(RO)₂Si(OH)₂+ROH
(RO)₂Si(OH)₂+H₂O→ROSi(OH)₃+ROH
ROSi(OH)₃+H₂O→Si(OH)₄+ROH
Each hydrolysis step produces a molecule of ethanol. Simultaneously, condensation reactions, such as the following, occur:
(C₂H₅O)₃SiOH+(C₂H₅O)₃SiOH→(C₂H₅O)₃SiOSi(C₂H₅O)₃+H₂O
or, more broadly, (RO)₃SiOH+(RO)₃SiOH(RO)₃SiOSi(RO)₃+H₂O

The condensation reactions are polymerization reactions in which a simple molecule is eliminated from the silicate and an oxygen-silicon-oxygen bond is formed.

TABLE I

| | solubility | | | molar |
|---|---|---|---|---|
| Compound | g/100 cc | | mol wt | solubility |
| Ca hydroxide | 0.16 | | 72 | 0.0223 |
| Ca acetate | 37.4 | (0) | 158 | 2.36 |
| Ca benzoate | 2.7 | (0) | 336 | 0.08 |
| Ca butyrate | soluble | | 268 | |
| Ca citrate | 0.85 | (18) | 570 | 0.015 |
| Ca formate | 16.2 | (20) | 130 | 1.25 |
| Ca fumarate | 2.11 | (30) | 205 | 0.103 |
| Ca d-gluconate | 3.3 | (15) | 448 | 0.074 |
| Ca glycerophosphate | 2 | (25) | 210 | 0.19 |
| Ca isobutyrate | 20 | | 304 | 0.658 |
| Ca lactate | 3.1 | (0) | 308 | 0.101 |
| Ca maleate | 2.89 | (25) | 172 | 0.168 |
| Ca methylbutryate | 24.24 | (0) | 242 | 1.002 |
| Ca propionate | 49 | (0) | 204 | 2.402 |
| Ca l-quinate | 16 | (18) | 602 | 0.266 |
| Ca salicyate | 4 | (25) | 350 | 0.114 |
| Ca valerate | 8.28 | (0) | 242 | 0.342 |
| Ca nitrate | 121.2 | (18) | 164 | 7.39 |
| Ca chromate | 16.3 | (20) | 192 | 0.849 |
| Ca ferrocyanide | 80.8 | (25) | 490 | 1.649 |
| Ca permanganate | 331 | (14) | 368 | 8.995 |
| Ca MCPM | 1.8 | (20) | 252 | 0.071 |
| Ca hypophosphate | 15.4 | (25) | 170 | 0.906 |
| Mg(OH)2 | .0009 | (18) | 58 | 5.6 × 10⁻¹¹ |
| Mg laurate | .007 | (25) | 459 | 1.5 × 10⁻⁴ |
| Mg myristrate | .006 | (15) | 479 | 1.3 × 10⁻⁴ |
| Mg oleate | .024 | (5) | 587 | 4.1 × 10⁻⁴ |
| Mg oxalate | .07 | (16) | 148 | 4.7 × 10⁻³ |
| Mg stearate | .003 | (14) | 591 | 5.1 × 10⁻⁵ |

value in parenthesis is the temperature at which the solubility was determined.

TABLE 2

| | | | | sol. | at | Advantages or |
|---|---|---|---|---|---|---|
| Compound name | Formula | abbr | mol wt | g/100 cc | ° C. | Disadvantages |
| aluminum nitrate | Al(NO3)3.9H2O | ANN | 375.13 | 63.7 | 25 | (−) sulfate |
| nonohydrate | | | | | | attack |
| calcium nitrate | Ca(NO3)2.4H2O | CNT | 236.15 | 266 | 0 | Stability |
| tetrahydrate | | | | | | question |
| calcium nitrate | Ca(NO3)2 | CN | 164.09 | 121 | 18 | |
| anhydrous | | | | | | |
| calcium nitrite | Ca(NO2)2.H2O | CAN | 150.11 | 45.9 | 0 | (−) expense |
| monohydrate | | | | | | |
| chromium nitrate | | | | | | (−) toxic |
| ferrous nitrate | | | | | | Stability |
| | | | | | | question |
| ferric nitrate | Fe(NO3)3.9H2O | FNN | 404.2 | sol | | (−) color |
| nonohydrate | | | | | | |
| ferric nitrate | Fe(NO3)3.6H2O | FNH | 348.4 | | | |
| hexahydrate | | | | | | |
| copper nitrate | Cu(NO3)2.6H2O | | 295.64 | 243.7 | 0 | |
| hexahydrate | | | | | | |
| copper nitrate | Cu(NO3)2.3H2O | | 241.6 | 137.8 | 0 | |
| trihydrate | | | | | | |
| copper nitrate | Cu(NO3)2.2.5H2O | | | | | |
| 2.5hydrate | | | | | | |
| magnesium nitrate | Mg(NO3)2.2H2O | MND | 184.35 | sol | | (+) expense |
| dihydrate | | | | | | |
| magnesium nitrate | Mg(NO3)2.6H2O | MNH | 256.41 | 125 | | |
| hexahydrate | | | | | | |
| manganese nitrate | Mn(NO3)2.4H2O | | 251.01 | 426.4 | 0 | |
| tetrahydrate | | | | | | |
| strontium nitrate | Sr(NO3)2 | SN | 211.63 | 70.9 | 18 | |
| anhydrous | | | | | | |
| strontium nitrate | Sr(NO3)2.4H2O | SNT | 283.69 | 60.43 | 0 | |
| tetrahydrate | | | | | | |
| zinc nitrate | Zn(NO3)2.3H2O | | 243.43 | | | |
| trihydrate | | | | | | |
| zinc nitrate | Zn(NO3)2.6H2O | | 297.47 | 181.3 | 20 | |
| hexahydrate | | | | | | |

molality = (wt in g of solid)(1/mw)/1000 g of H2O. 10% soln = 100 g solid + 900 g H2O = 111.1 g solid/1000 g soln or 111.1 g of solid per 1000 g of sol'n

TABLE 3

| | | | | | | | Wt | Wt of | |
|---|---|---|---|---|---|---|---|---|---|
| | 10 wt % | | | | | | NaOH/ | nitrate | pH |
| | soln, | molality × moles | wt | wt | wt % | soln | Ca(OH)2 | soln | after |
| Formula | molality | NO3 | solid, g | H2O + Solid | solid, g | pH | soln*, g | added, g | add'n |
| Al(NO3)3.9H2O | 0.296 | 0.888 | 5.02 | 51.79 | 9.69 | 1.85 | 39.51 | 8.67 | 12.34 |
| Ca(NO3)2.4H2O | 0.47 | 0.92 | 5.2 | 52.08 | 9.98 | 5.38 | 41.76 | 13.61 | 12.36 |
| Ca(NO3)2 | 0.677 | 1.334 | | | | | | | |
| Ca(NO2)2.H2O | 0.74 | 1.48 | | | | | | | |
| Fe(NO3)3.9H2O | 0.274 | 0.822 | 5.04 | 54.07 | 9.32 | 0.3 | 39.44 | 11.64 | 12.46 |
| Fe(NO3)3.6H2O | 0.319 | 0.958 | | | | | | | |
| Cu(NO3)2.6H2O | 0.378 | | | | | | | | |
| Cu(NO3)2.3H2O | 0.46 | | 5.07 | 50.98 | 9.93 | | | | |
| Cu(NO3)2.2.5H2O | | | | | | 2.87 | | | |
| Mg(NO3)2.2H2O | 0.602 | 1.204 | | | | | | | |
| Mg(NO3)2.6H2O | 0.433 | 0.866 | 5.08 | 50.07 | 10.14 | 4.91 | 42.78 | 18.03 | 12.56 |
| Mn(NO3)2.4H2O | 0.443 | 0.886 | | | | | | | |
| Sr(NO3)2 | 0.525 | 1.05 | | | | | | | |
| Sr(NO3)2.4H2O | 0.392 | 0.784 | | | | | | | |
| Zn(NO3)2.3H2O | 0.456 | 0.912 | | | | | | | |
| Zn(NO3)2.6H2O | 0.373 | 0.746 | | | | | | | |

*0.3 M NaOH + 10 g Ca(OH)2 + 0.005 M Na2SO4 pH before any additions = 13.02

### EXAMPLES

The following examples are intended to illustrate the invention and should not be construed as limiting the invention in any way.

It is understood in the art that a low alkali cement contains less than about 0.6 wt % of Na₂O equivalent. Na₂O equivalent is the total amount of both Na₂O and K₂O present in the cement, reported as Na₂O equivalents. Recognizing that Na₂O+2H₂O→2NaOH, one can calculate the amount of a salt that is required to reduce the effective Na₂O equivalent to the desired value. The following examples illustrate one embodiment of the present invention, in which there is added sufficient salt to bring the effective Na₂O equivalent to this 0.6% value.

### Example 1

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94×0.01=5.17 lb. To bring this value down to an Na₂O equivalent 0.6% requires neutralization of 0.4×5.17=2.07 lb. If the preferred admixture is Ca(NO₃)₂ then on a molar basis, Na₂O+2H₂O+Ca(NO₃)₂→Ca(OH)₂+2NaNO₃. Thus, one mole of Ca(NO₃)₂ would be required for each mole of Na₂O to be neutralized.

Based on the molecular weights per mole, neutralization of 62 g of Na₂O would require 164 g of Ca(NO₃)₂. This ratio is 2.65. Thus, 2.07 lb of Na₂O-would require the presence of 5.48 lb of Ca(NO₃)₂ per cubic yard of concrete. If the water-to-cement ratio were 0.5, the concrete would be made by mixing the cement with 5.5×94×0.5=258.5 lb of water per cubic yard. Calcium nitrate can be added to this mixing water as crystals that would readily dissolve.

### Example 2

An alternative method for reducing hydroxyl ions in concrete is to limit the total alkali content in a cubic yard of concrete. The alkali content in a cubic yard of concrete will increase as the cement content of the concrete increases. The if one mix uses 4.5 sack per cubic yard while another uses 7 sack per cubic yard of the same cement. The alkali content of the 7 sack mix will be 7/4.5=1.56 times higher than that of the 4.5 sack mix. In metric units alkali silica reaction is not considered a problem is the Na₂O equivalent is in the range of 1.8 to 3 kilograms per cubic meter (1.31 cu yard). Assume a typical cement content of 13 weight percent and a typical weight of a cubic meter of concrete to be 2400 kg and a Na₂O equivalent of 1%. Thus the total alkali equivalent will be 2400×0.13×0.01=3.12 kg for the equivalent of a 5.5 sack mix and 4.87 kg for a 7 sack mix. In the latter instance a reduction of the content to a maximum of 3 kg per cubic meter would require the addition of sufficient Ca(NO₃)₂ to reduce the Na₂O equivalent by 1.87 kg/cubic meter. Again, according to the reaction Na₂O+2H₂O+Ca(NO₃)₂→Ca(OH)₂+2NaNO₃, this would require the addition of 4.95 kg of calcium nitrate.

### Example 3

### Use of an Organic Salt

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94×0.01=5.17 lb. To bring this value down to an Na₂O equivalent 0.6% requires neutralization of 0.4×5.17=2.07 lb. If the preferred admixture is calcium acetate then on a molar basis, Na₂O+2H₂O+Ca(Ac)₂→Ca(OH)_{2(solid)}+2NaAc. Thus, one mole of Ca(Ac)₂ would be required for each mole of Na₂O to be neutralized.

Based on the molecular weights per mole, neutralization of 62 g of Na₂O would require 158 g of Ca(NO₃)₂. This weight ratio is 2.55. Thus, 2.07 lb of Na₂O would require the presence of 5.28 lb of Ca(Ac)₂ per cubic yard of concrete. If the water-to-cement ratio were 0.5, the concrete would be made by mixing the cement with 5.5×94×0.5=258.5 lb of water per cubic yard. Calcium acetate can be added to this mixing water as crystals that would readily dissolve.

### Example 4

### Use of a Free Organic Acid

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94×0.01=5.17 lb. To bring this value down to an Na₂O equivalent 0.6% requires neutralization of 0.4×5.17=2.07 lb. If the preferred admixture is oxalic acid then on a molar basis,
Na₂O+2H₂O+HO₂CCO₂H→Na₂(COO)₂. Thus, one mole of oxalic acid would be required for each mole of Na₂O to be neutralized.

Based on the molecular weights per mole, neutralization of 62 g of Na₂O would require 90 g of oxalic acid. This weight ratio is 1.45. Thus, 2.07 lb of Na₂O would require the presence of 3 lb of oxalic acid per cubic yard of concrete. If the water-to-cement ratio were 0.5, the concrete would be made by mixing the cement with 5.5×94×0.5=258.5 lb of water per cubic yard. Oxalic acid can be added to this mixing water as crystals. Alternatively, oxalic acid dehydrate crystals could be added provided the proportions were altered to consider the molecular weight difference.

### Example 5

### Use of an Alkoxide

Assume a cement with an Na₂O equivalent of 1%. To convert this to a low alkali cement, 0.4 wt % of Na₂O needs to be neutralized. Assume a typical mix design called for 5.5 sacks of cement per cubic yard and a water-to-cement ratio of 0.5 by weight. A sack of cement weights 94 pounds. Consequently, the total Na₂O equivalent would be 5.5×94×0.01=5.17 lb. To bring this value down to an Na₂O equivalent 0.6% requires neutralization of 0.4×5.17=2.07 lb. TEOS, tetraethyl oxysilane is a liquid at room temperature which has a limited solubility in water. In the proportions needed it will be soluble with the mixing water used to produce concrete. TEOS liquid will be added to the mixing water and will hydrolyze to produce oligomers of approximate composition SiₙO₍₂ₙ₊₁₎H₍ₙ₊₂₎. These will react in turn with Na and hydroxyls to produce Na₂SiO₃.9H₂O. Thus, 1 mole of Na₂O is consumed per mole of TEOS. On a weight ratio basis, 208 g of TEOS are required per 62 g of Na₂O. Thus to neutralize 2.07 lb of Na₂O will require 6.94 lb of TEOS. Given a density of TEOS liquid of about 1.4, this will require about 0.5 liter per cubic yard of concrete.

### Example 6

### Remediation of Existing Concrete

The reaction in concrete presently undergoing ASR can be stopped by allowing solution containing calcium nitrate to soak into the concrete. As this occurs, the reaction 2NaOH+2H₂O+Ca(NO₃)₂→Ca(OH)₂+2NaNO₃ will propagate.

A similar reaction will occur in the event the alkali is potassium. In this case the reaction
2KOH+2H₂O+Ca(NO₃)₂—Ca(OH)₂+2KNO₃ will propagate. Application to hardened concrete pavements can be accomplished by spraying using equipment equivalent to that used to apply liquid de-icing salts. Application to horizontal or vertical surfaces can be accomplished by saturating porous materials, including but not limited to paper, cloth, or burlap, and placing them in direct contact with the concrete. This recognizes that means to limit the rate of evaporation, such as covering with plastic sheeting, should be employed.

Rather than employing a soft material, such as cloth, paper or burlap, the salts needed to interfere with ASR can be employed by incorporating them into a porous overlay. Such an overlay could be concrete, mortar, or asphaltic material.

Whereas particular embodiments of this invention have been described above for A purposes of illustration, it will be evident to those skilled in the art that numerous variations of the details of the present invention may be made without departing from the invention as defined in the appended claims.

1. A method of reducing hydroxyl ions in concrete pore solutions containing alkali metal cations and hydroxyl ions, comprising adding a salt to fresh concrete, wherein said salt comprises a cation, denoted herein as Cat, and an anion, denoted herein as An, said cation having a higher valence than said anion, said Cat-An salt having a solubility in water that is greater than Cat-OH, such that when said Cat-An salt precipitates as Cat-OH the resulting alkali metal-An salt formed remains in solution or has a solubility in the concrete pore solution greater than that of said Cat-An salt.

2. The method of claim 1, wherein said cation is selected from the group consisting of are Ca, Fe, Mg, Mn, Al, Cu, Zn, Sr, Ti and combinations thereof.

3. The method of claim 2, wherein said cation is Ca.

4. The method of claim 1, wherein said anion is selected from the group consisting of nitrate, nitrite, acetate, benzoate, butyrate, citrate, form ate, fumarate, gluconate, glycerophosphate, isobutyrate, lactate, maleate, methylbutyrate, oxalate, propionate, quinate, salicylate, valerate, chromate, tungstate, ferrocyanide, permanganate, monocalcium phosphate monohydrate, hypophosphate, and combinations thereof.

5. The method of claim 4, wherein said anion is nitrate.

6. (canceled)

7. The method of claim 1, wherein said salt is added to said fresh concrete as a solid.

8. The method of claim 1, wherein said salt is added to said fresh concrete as an aqueous solution.

9. (canceled)

10. The method of claim 1, wherein said salt is added to an overlay over existing concrete.

11. The method of claim 1, wherein said salt is added in an amount sufficient to bring the effective Na₂O equivalent to less than about 0.8% by weight of cement in said concrete.

12. A method of reducing hydroxyl ions in concrete pore solutions containing alkali metal cations and hydroxyl ions, comprising adding a salt to said concrete, wherein said salt comprises a cation, denoted herein as Cat, and an anion, denoted herein as An, said cation having a higher valence than said anion, said Cat-An salt having a solubility in concrete pore solutions having pH values higher than that of a saturated Cat(OH)₂₊ₓ, wherein x is a whole number equal or greater than zero, solution in water that is greater than Cat-OH, such that when said Cat-An salt precipitates as Cat-OH the resulting alkali metal-An salt formed remains in said solution or has a solubility in said concrete pore solution greater than that of said Cat-An salt.

13. The method of claim 12, wherein said cation is selected from the group consisting of are Ca, Fe, Mg, Mn, Al, Cu, Zn, Sr, Ti and combinations thereof.

14. The method of claim 13, wherein said cation is Ca.

15. The method of claim 12, wherein said anion is selected from the group consisting of nitrate, nitrite, acetate, benzoate, butyrate, citrate, formate, fumarate, gluconate, glycerophosphate, isobutyrate, lactate, maleate, methylbutyrate, oxalate, propionate, quinate, salicylate, valerate, chromate, tungstate, ferrocyanide, permanganate, monocalcium phosphate monohydrate, hypophosphate, and combinations thereof.

16. The method of claim 15, wherein said anion is oxalate.

17. The method of claim 12, wherein said salt is added to fresh concrete.

18. The method of claim 17, wherein said salt is added to said fresh concrete as a solid.

19. The method of claim 17, wherein said salt is added to said fresh concrete as an aqueous solution.

20. The method of claim 12, wherein said salt is introduced into hardened concrete.

21. The method of claim 12, wherein said salt is added to fresh concrete for use as an overlay over existing concrete, or is introduced into a hardened concrete overlay over existing concrete.

22. The method of claim 12, wherein said salt is added in an amount sufficient to bring the effective Na₂O equivalent to less than about 0.8% by weight of cement in said concrete.

23. The method of claim 12, wherein said salt is added in an amount sufficient to bring the effective Na₂O equivalent to a value lower than the effective Na₂O equivalent of the cement used in making said concrete.

24. A method of reducing hydroxyl ions in concrete pore solutions containing alkali metal cations and hydroxyl ions, comprising adding a free organic acid to said concrete.

25. The method of claim 424, wherein said free organic acid is selected from the group consisting of acetic acid, benzoic acid, butyric acid, citric acid, formic acid, fumaric acid, gluconic acid, glycerophosphoric acid, isobutyric acid, lactic acid, maleic acid, methylbutyric acid, oxalic acid, propionic acid, quinic acid, salicylic acid, valeric acid, and combinations thereof.

26. The method of claim 25, wherein said free organic acid is oxalic acid.

27. The method of claim 24, wherein said acid is added to fresh concrete.

28. The method of claim 27, wherein said acid is added to said fresh concrete as a solid.

29. The method of claim 27, wherein said acid is added to said fresh concrete as an aqueous solution.

30. The method of claim 24, wherein said acid is introduced into hardened concrete.

31. The method of claim 24, wherein said acid is added to fresh concrete for use as an overlay over existing concrete, or is introduced into a hardened concrete overlay over existing concrete.

32. The method of claim 24, wherein said acid is added in an amount sufficient to bring the effective Na₂O equivalent to less than about 0.8% by weight of the cement in said concrete.

33. A method of reducing hydroxyl ions in concrete pore solutions, comprising adding an acidic phosphate to said concrete.

34. The method of claim 33, wherein said acidic phosphate is phosphoric acid.

35. The method of claim 33, wherein said acidic phosphate is monobasic phosphate.

36. The method of claim 33, wherein said acidic phosphate is dibasic phosphate.

37. The method of claim 33, wherein the cation of said acidic phosphate is selected from the group consisting of Na⁺, K⁺, NH₄⁺ and combinations thereof.

38. The method of claim 33, wherein said acidic phosphate is added to fresh concrete.

39. The method of claim 38, wherein said acidic phosphate is added to said fresh concrete as a solid.

40. The method of claim 38, wherein said acidic phosphate is added to said fresh concrete as an aqueous solution.

41. The method of claim 33, wherein said acidic phosphate is introduced into hardened concrete.

42. The method of claim 33, wherein said acidic phosphate is added to fresh concrete for use as an overlay over existing concrete, or is introduced into a hardened concrete overlay over existing concrete.

43. The method of claim 33, wherein said acidic phosphate is added in an amount sufficient to bring the effective Na₂O equivalent to less than about 0.8% by weight of the cement in said concrete.

44-54. (canceled)

55. The method of claim 1, wherein said salt is added in an amount sufficient to bring the effective Na₂O equivalent to an amount which is less than the effective Na₂O equivalent of the cement used in said concrete.

56. The method of claim 33, wherein said acidic phosphate is added in an amount sufficient to bring the effective Na₂O equivalent to an amount which is less than the effective Na₂O equivalent of the cement used in said concrete.

57. (canceled)
